(19) United States
(12) Patent Application Publication
(10) Pub. No.: US 2012/0016806 A1
(43) Pub. Date: Jan. 19, 2012

(54) METHOD AND SYSTEM FOR FACILITATING LONG TERM PROCESS ADOPTION IN AN ORGANIZATION

(75) Inventor: Gaurav Rastogi, Dublin, CA (US)

(73) Assignee: Infosys Technologies Limited, Bangalore (IN)

(21) Appl. No.: 12/902,497

(22) Filed: Oct. 12, 2010

(30) Foreign Application Priority Data
Jul. 14, 2010 (IN) 1997/CHE/2010

(51) Int. Cl. G06Q 10/00

(52) U.S. Cl. 705/345

(57) ABSTRACT

A method for facilitating and improving process adoption in an organization is provided. The organization has a plurality of processes to carry out organizational tasks. The method includes receiving a set of priorities about the organization from at least one stakeholder in the organization. Further, the method includes the step of receiving a set of attributes about the organization from the at least one stakeholder in the organization. Furthermore the method includes the step of processing, on a computer, the set of priorities and the set of attributes to generate an optimal plan of training end users in the organization. The plan of training is designed to facilitate the process adoption. Finally, the method includes the step of monitoring the end users to improve the process adoption.

### FIELD OF THE INVENTION

The present invention relates, in general, to process adoption and learning techniques and more particularly to systems and methods for facilitating long term process adoption in an organization.

### BACKGROUND OF THE INVENTION

As companies move towards better management of organizational tasks, introduction of numerous processes is inevitable. Processes in an organization include, but are not limited to, leave application process, travel arrangement process, quality process, and project management process. Each of these processes involves a workflow. A typical workflow includes seeking approvals, usage of applications, following guidelines etc.

Employees in the organization are expected to understand the usage of these applications and follow the processes efficiently. To educate employees of the processes, organizations across the world spend enormous resources in training them. In such training programs all or a section of employees are trained in the usage of applications. The training programs typically involve testing the employees at the end of the sessions. The training programs are plagued with problems related to their reach, efficiency in helping employees retain the knowledge, and convenience to employees across the organization. Typically, organizations are only able to reach a fraction of the overall user base of an application over the lifespan of the application. This implies that a majority of the end-users are not made knowledgeable about the applications by the organization, and have to depend on personal investigation through the “hit and trial” method, or by inquiring amongst geographically proximate colleagues. This further implies that organizations have a majority of employees who use the application in ways not intended by the organization, and that the resulting utility of the application to the organization is much reduced. Further, the training programs are not planned in such a way that the employees who are likely to use the process more are trained before the other employees that may be more senior in the organization, but may be infrequent users of the said applications.

Most applications related to processes in the organization have manuals associated with them that guide an employee during the usage. These training manuals cover specific cases and are not helpful in many usage scenarios. Organizations also try to reach employees through road-shows and posters about a process. This method covers the problem of reach in other methods discussed above but that do not solve the problem of efficiently imparting knowledge. Various other non-traditional methods like role play, simulations, blogs, and discussion forums are used in organizations to make sure that all the knowledge of a process reaches employees. As much as these methods help in reaching out to employees, the problem of myriad sources of information doesn't help in improving the efficiency and efficacy of imparting technical knowledge about the usage of the said applications.

Further, organizations use methods such as e-learning, and instructor led training during the launch of the process and rely on passive sources of information (user manuals, discussion forums etc.) for continual knowledge transfer. The employees that join after the process is launched are thus left with getting knowledge about processes through other colleagues and sources such as discussion forums and passive sources of information, such as manuals, about the application that may contain outdated information about the usage of the applications.

Hence there is a need of a method and a system that can help an organization in systematically planning the usage of existing learning techniques to train its employees about a process. The method and system should provide an organization with a plan of using modes of training in the best possible manner to ensure that all the relevant employees are covered and the knowledge about the process is retained. The method and system should also provide the organization with a plan for continual improvement of process knowledge among its employees.

### BRIEF SUMMARY OF THE INVENTION

The above mentioned shortcomings, disadvantages and problems are addressed herein and will be understood by reading and studying the following specification.

The various embodiments of the present invention provide a system and method to facilitate and improve process adoption in an organization.

According to one embodiment of the present invention, a method for facilitating and improving process adoption in an organization is provided. The method includes the step of receiving, from at least one stakeholder in the organization, a set of priorities about the organization. The method further includes the step of receiving, from the at least one stakeholder in the organization, a set of attributes about the organization. Further, the set of priorities and the set of attributes are processed on a computer to generate an optimal plan of training end users in the organization. The plan of training is designed to effectively facilitate the process adoption, and sustain this adoption throughout the lifespan of the underlying process. Furthermore, the method includes the step of monitoring the end users to improve the process adoption.

According to another embodiment of the present invention, a method to train end users in an organization about a process is provided. The method includes the step of communicating to the end users, by a plurality of means, about the process. Further, the method includes training the end users about a plurality of activities in the process. The method also includes the step of assessing the end users, through context sensitive tests. Furthermore, the method includes providing means, with the help of context sensitive help and discussion forums, to help the end users to continually improve their knowledge about the process.

According to yet another embodiment of the present invention, a system for facilitating and improving process adoption in an organization is provided. The system comprises receiving module to receive a set of priorities and a set of attributes about the organization from at least one stakeholder in the organization. The system also includes a processing module to process the set of priorities and the set of attributes to generate a plan of training end users in the organization. The plan of training generated by the processing module is designed to facilitate the process adoption. Further, the system includes a monitoring module to monitor the end users to improve the process adoption. Furthermore, the system includes an enablement module to provide with means to continually improve knowledge of the end users about the process.

### BRIEF DESCRIPTION OF THE DRAWINGS

The other objects, features and advantages will occur to those skilled in the art, from the following description of the preferred embodiment and the accompanying drawings in which:

FIG. 1 illustrates a flow chart representing workflow involved in a process in an organization;

FIG. 2 illustrates a flowchart of a method for facilitating and improving process adoption in an organization, according to one embodiment of the present invention;

FIG. 3 illustrates a flowchart of a method to train end users in an organization about a process, according to one embodiment of the present invention;

FIG. 4 is a block diagram of a system for facilitating and improving process adoption in an organization, according to various embodiments of the present invention; and

FIG. 5 is a system illustrating a generalized computer network arrangement, in one embodiment of the present invention.

Although specific features of the present invention are shown in some drawings and not in others. This is done for convenience only as each feature may be combined with any or all of the other features in accordance with the present invention.

### DETAILED DESCRIPTION

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

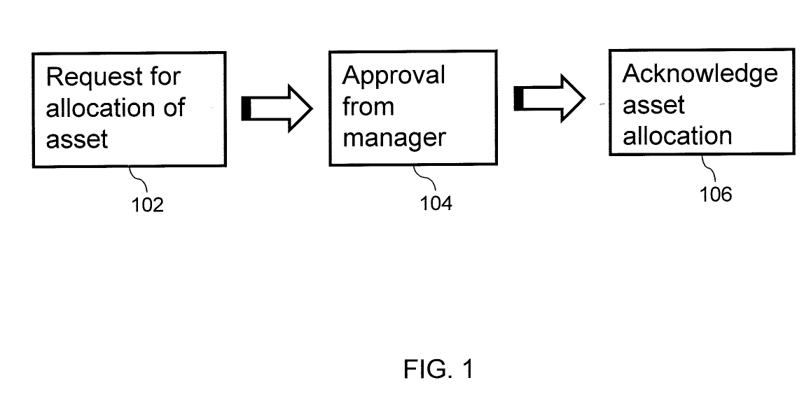

The various embodiments of the present invention provide a system and method to facilitate and improve process adoption in an organization. An organization has a plurality of processes to carry out organizational tasks. These processes involve a workflow and usage of plurality of applications. Users in the organization need to be trained regarding the workflow and the plurality of applications. FIG. 1, for example, illustrates a sample process in an organization.

The process shown in FIG. 1 is an asset allocation and management process in an organization. The process involves step 102 of an employee in the organization requesting for allocation of an asset. An asset can be, for example, a mobile phone, a computer, a desk, a cabin, or software. The request can be sent through modes that include, but are not limited to, e-mail, a requisition letter or form, and an online asset requisition system. Once a request is placed, at step 104 approvals are sought from managers of the employee who had sent the request. The approvals could be obtained either through an online system or a mail could be sent to the manager requesting for an e-mail approval from him/her for the asset allocation. Finally, the process, at step 106 involves informing the employee about the allocation of the asset and details regarding asset collection. Further, the step also involves getting an acknowledgement for the asset allocation from the employee. This and many such processes of varied complexities are used in the organization to carry out organizational tasks. Hence there is a need to train end users in using applications and facilitate process adoption across the organization.

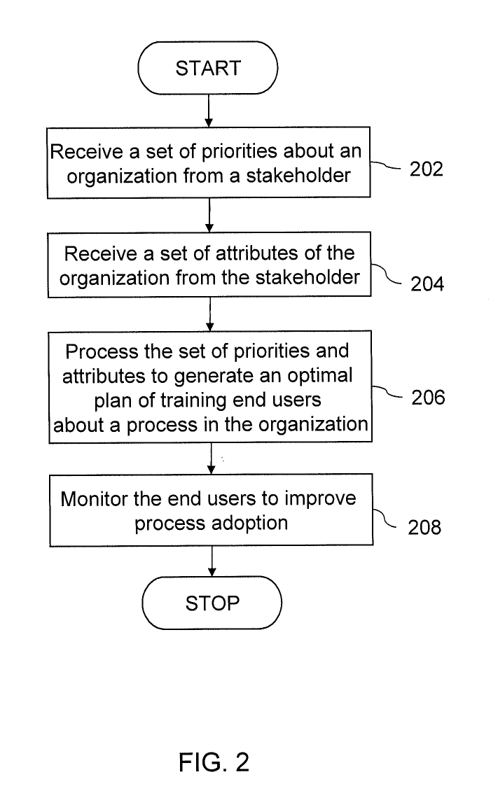

FIG. 2 illustrates a flow chart of a method for facilitating and improving process adoption in an organization, according to one embodiment of the present invention. At step 202, a set of priorities about the organization are received from a stakeholder of the organization. At step 204, a set of attributes related to the organization are received from the stakeholder of the organization. Further, at step 206, the set of priorities and the set of attributes of the organization are processed to generate an optimal plan of training end users in the organization. The plan of training is designed to facilitate process adoption in the organization. Furthermore, at step 208, the end users are monitored to improve the process adoption.

The set of priorities of an organization relate to the process that needs to be communicated across the organization. According to one embodiment of the present invention, the set of priorities includes reach of the process. Reach of the process is defined by the number of end users in the organization expected to use the process. According to another embodiment of the present invention, the set of priorities includes time for process adoption. Some processes need to be launched quickly in the organization and it is expected that the end users are trained quickly to adopt these processes. With regards to such processes the time for process adoption becomes a top priority. Furthermore, the set of priorities for an organization during process adoption includes a need to maintain business continuity. There is a possibility that while end users are being trained regarding a process, normal business operations get disrupted. Avoiding this can be a priority for the organization, during process adoption. According to yet another embodiment of the present invention, the set of priorities includes training those roles of users that are highly likely to use the process before other users from the organization.

The set of attributes of the organizations that are entered by the stakeholder define the current state of the organization. According to one embodiment of the present invention, the set of attribute includes geographical location of the end users. Current organizations have a global presence and end users can be located in different time zones. This aspect in the organization where end users are spread across geographies is entered by the stakeholder to aid the method of facilitating process adoption. Further, the set of attributes also includes a turnover in the end users. Turnover in the end users defines the volume of new users joining the organization as compared to the exit of old end users. In case the turnover is high, the method will generate a training plan that includes many revisions of the training or making the training available on a fixed resource. Furthermore, the set of attributes also includes a frequency of usage of the process that needs to be percolated in the organization. In case the process is used frequently in the organization, the optimal training plan will include rigorous testing methods and also include more resources to help the end users. According to another embodiment of the present invention, the set of attributes also includes magnitude of changes a new process in going to bring about in the older processes in the organization. According to yet another embodiment of the present invention, the set of attributes includes selecting high frequency end users from all the end users in the organization.

At step 206 in the method, the set of priorities and the set of attributes of the organization are processed to generate an optimal plan of training end users in the organization about the process. In the step 206, according to one embodiment of the present invention, a weight is assigned to each of the set of priorities and set of attributes. The total weight is used to generate the training plan for the end users in the organization. The training plan includes various training mechanisms for the end users. These training mechanisms are arranged in a systematic order to aid the end users. The training mechanisms include, but are not limited to, online assessment, user generated help content like Wiki, instructor led training, e-learning, blogs about the process, context sensitive help addressing various scenarios of usage in the training, role play and stimulation.

Further, monitoring of end users at step 208 is carried out using various examinations and assignments through online or written means.

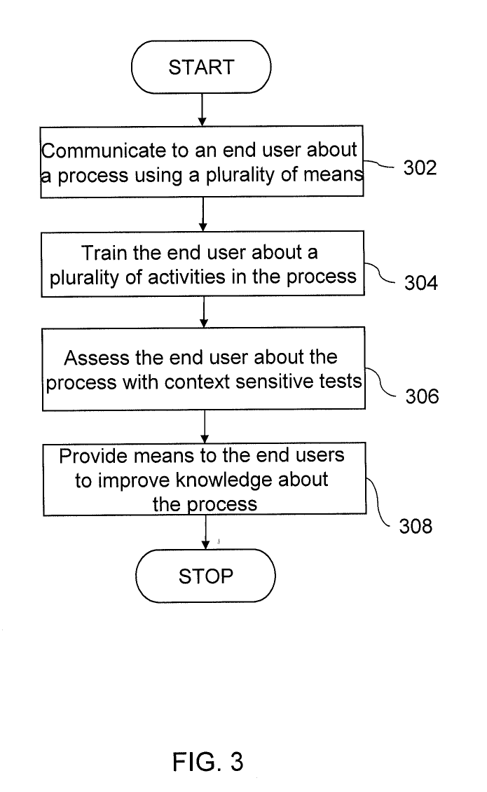

FIG. 3 illustrates a flowchart of a method to train end users in an organization about a process, according to one embodiment of the present invention. At step 302 in the method, end users in the organization are communicated about the process using a plurality of means. Further, at step 304, the end users are trained about a plurality of activities in the process. At step 306 in the method, the end users are assessed about their knowledge of the process with context sensitive tests. Finally, at step 308, based on the assessment means are provided to the end users to improve their knowledge of the process.

According to one embodiment of the present invention, the plurality of means of communicating with the end users include, but are not limited to, electronic mail, posters, banners, videos, e-learning sessions, classroom sessions, and brochures. These means are used to introduce and create awareness about the process among the end users. Once sufficient information is passed on to the end users through the plurality of means, the end users are trained using an optimal training plan using varied means of training. The means of training the end users include, but are not limited to, simulations, context sensitive help, community web-pages, discussion forums, e-learning systems, online training systems, and classroom training. These means of training are used to train the end users in the process and the plurality of activities involved in the process. Further, the method also provides for means help end users continually improve their knowledge of the process. The means for improving knowledge includes user editable web-pages (ex: team wiki, discussion forums, and blogs).

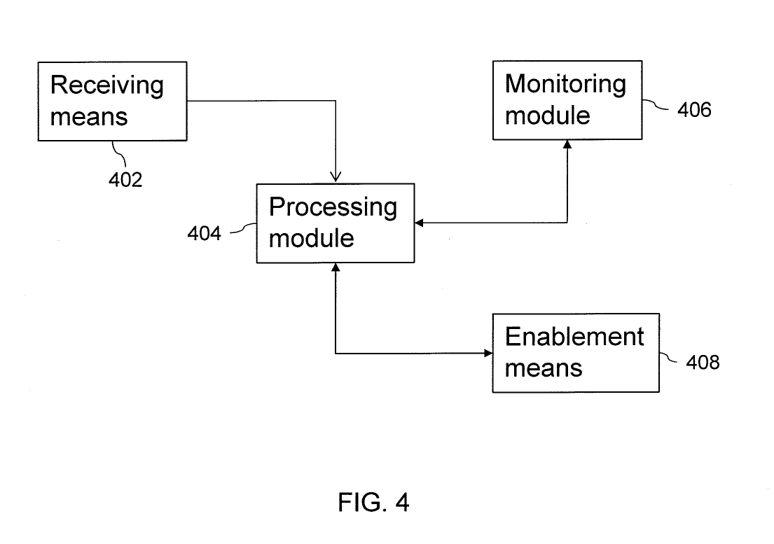

FIG. 4 is a block diagram of a system for facilitating and improving process adoption in an organization, according to various embodiments of the present invention. The system includes a receiving module 402 to receive a set of priorities and a set of attributes of the organization from at least one stakeholder in the organization. Further, the system includes a processing module 404 to process the set of priorities and the set of attributes to generate a plan of training end users in the organization, wherein the plan of training is designed to facilitate the process adoption. The system also includes a monitoring module 406 to monitor the end users to improve the process adoption. Furthermore, the system includes an enablement module 408 to provide with means to continually improve knowledge of the end users about the process.

According to one embodiment of the present invention, the enablement module 408 includes a community web-page about the process. The community web-page can host discussions about the process and provide solutions for problems faced by the end users. The community web-page can also host other training materials that may be created for a multitude of training mechanisms. The community web-page can be edited by the end user to include new information about the process, report problems with applications that concern the process. According to another embodiment of the present invention, the enablement module 408 includes a network of end users to facilitate knowledge sharing among the end users. The network of end users may include subject matter experts who can guide the end users in understanding the process properly. According to yet another embodiment of the present invention, the monitoring module 406 includes an assessment module to assess the end users for their knowledge of the process. The assessment module hosts various assessments in the form of quizzes, exams, surveys to assess the end users.

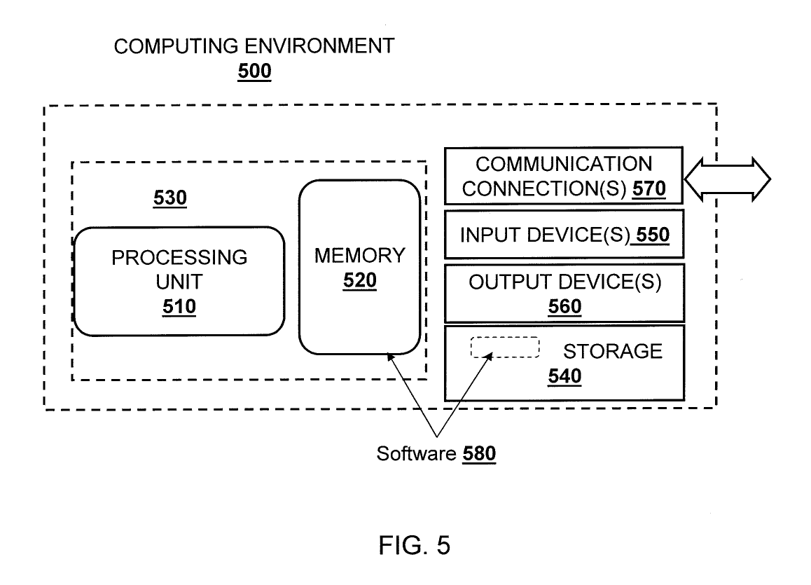

One or more of the above-described techniques may be implemented in or involve one or more computer systems. FIG. 5 illustrates a generalized example of a computing environment 500. The computing environment 500 is not intended to suggest any limitations as to scope of use or functionality of described embodiments.

With reference to FIG. 5, the computing environment 500 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 580 implementing described techniques.

A computing environment may have additional features. For example, the computing environment 500 includes storage 540, one or more input devices 550, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which may be used to store information and which may be accessed within the computing environment 500. In some embodiments, the storage 540 stores instructions for the software 580.

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

The communication connection(s) 570 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 500, computer-readable media include memory 520, storage 540, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

1. A computer implemented method for facilitating and improving process adoption in an organization, wherein the organization has a plurality of processes to carry out organizational tasks, the method comprising:
receiving, from at least one stakeholder in the organization, a set of priorities about the organization;
receiving, from the at least one stakeholder in the organization, a set of attributes about the organization;
processing, on a computer, the set of priorities and the set of attributes to generate an optimal plan of training end users in the organization, wherein the plan of training is designed to facilitate the process adoption; and
monitoring the end users to improve the process adoption.

2. The computer implemented method as recited in claim 1, wherein the step of processing the set of priorities and the set of attributes comprises assigning a weight to each of the set of priorities and the set of attributes.

3. The computer implemented method as recited in claim 1, wherein generating the plan of training comprises selecting a training mechanism for the end users from a group of mechanisms comprising online assessment, user generated help content, instructor led training, e-learning, blogs, context sensitive help, role play, and simulation.

4. The computer implemented method as recited in claim 1, wherein the set of priorities comprises reach of the process, and wherein reach of the process is defined by the number of end users for the process.

5. The computer implemented method as recited in claim 1, wherein the set of priorities comprises time for process adoption, and wherein time for the process adoption depends on importance of the process.

6. The computer implemented method as recited in claim 1, wherein the set of priorities comprises maintaining business continuity.

7. The computer implemented method as recited in claim 1, wherein the set of priorities comprises an anticipated life span of the process.

8. The computer implemented method as recited in claim 1, wherein the set of priorities comprises minimizing cost of the process adoption.

9. The computer implemented method as recited in claim 1, wherein the set of priorities comprises training those roles of users that are highly likely to use the process before other users from the organization.

10. The computer implemented method as recited in claim 1, wherein the set of attributes comprises geographical location of the end users.

11. The computer implemented method as recited in claim 1, wherein the set of attributes comprises turn over in the end users, where turnover is defined as the addition of new users and the reduction of earlier users over a life span of the process.

12. The computer implemented method as recited in claim 1, wherein the set of attributes comprises frequency of usage of the process.

13. The computer implemented method as recited in claim 1, wherein the set of attributes comprises an anticipated magnitude of change to old processes over a life span of the process.

14. The computer implemented method as recited in claim 1, wherein the set of attributes comprises selecting end users that have a high frequency of usage of the process.

15. A computer implemented method to train end users in an organization about a process, the method further comprising:
communicating to the end users, by a plurality of means, about the process;
training the end users about a plurality of activities in the process;
assessing the end users, through context sensitive tests; and
providing means, with the help of context sensitive help and discussion forums, to help the end users to continually improve their knowledge about the process.

16. The computer implemented method of claim 15, wherein the plurality of means comprise at least one of a group comprising electronic mail, video, e-learning, posters, classroom sessions, and brochures.

17. The computer implemented method of claim 15, wherein means for training the end users comprises at least one of a group of mechanisms comprising simulations, context sensitive help, community web-pages, discussion forums, e-learning systems, online training systems, and classroom training.

18. The computer implemented method of claim 15, wherein providing means for helping the end users improve their knowledge comprises creating a user-editable web page about the process.

19. A system for facilitating and improving process adoption in an organization, wherein the organization has a plurality of processes to carry out organizational tasks, the system comprising:
a receiving module to receive a set of priorities and a set of attributes about the organization from at least one stakeholder in the organization;
a processing module to process the set of priorities and the set of attributes to generate a plan of training end users in the organization, wherein the plan of training is designed to facilitate the process adoption;
a monitoring module to monitor the end users to improve the process adoption; and
an enablement module to provide with means to continually improve knowledge of the end users about the process.

20. The system as recited in claim 19, wherein the enablement module include a community web-page about the process, and wherein the community web-page can be edited by the end user to include new information.

21. The system as recited in claim 19, wherein the monitoring module comprises an assessment module to assess the end users for their knowledge of the process.

22. The system as recited in claim 19, wherein the enablement module comprises a network of end users to facilitate knowledge sharing between the end users.

23. A computer program product for facilitating and improving process adoption in an organization, wherein the organization has a plurality of processes to carry out organizational tasks, and wherein the computer program product comprises at least one computer-readable storage medium having computer-readable program code portions stored therein, the computer-readable program code portions comprising:
a program code configured to receive a set of priorities and a set of attributes about the organization from at least one stakeholder in the organization;
a program code configured to process the set of priorities and the set of attributes to generate a plan of training end users in the organization, wherein the plan of training is designed to facilitate the process adoption;
a program code configured to monitor the end users to improve the process adoption; and
a program code configured to provide with means to continually improve knowledge of the end users about the process.
